(19) United States
(12) Patent Application Publication
(10) Pub. No.: US 2017/0333172 A1
(43) Pub. Date: Nov. 23, 2017

(54) TOOTHBRUSH AND TOOTHBRUSH HANDLE WITH FINGER LOCATOR ZONES

(71) Applicant: Pogolab Ltd., London (GB)

(72) Inventor: Wen Zheng, London (GB)

(73) Assignee: Pogolab Ltd., London (GB)

(21) Appl. No.: 15/526,949

(22) PCT Filed: Jul. 31, 2015
(86) PCT No.: PCT/GB2015/000223

§ 371 Date: May 15, 2017

(30) Foreign Application Priority Data
Jul. 31, 2014 (GB) 1413575.0

(51) Int. Cl. A61C 17/22; A46B 15/00; A46B 9/04; B25G 1/10; A46B 5/00

(52) U.S. Cl. CPC A61C 17/225; B25G 1/102; A61C 17/221; A46B 5/0095; A46B 9/04; A46B 15/004

(57) ABSTRACT

Handle of toothbrush including a central region to locate fingers, and an index finger locator zone. The central region including thumb zone and two other finger locator zones, for receiving the thumb and middle finger on opposite sides of the central region of the toothbrush handle. Toothbrush having such handle and attachment configured for attachment to the handle of a toothbrush wherein the attachment including thumb zone and two other finger locator zones, for receiving the thumb and middle finger on opposite sides.

### BACKGROUND OF THE INVENTION

Tooth decay is the most common preventable disease around the world. It is widely suggested that people should brush their teeth two times per day to prevent tooth decay however many people do not use good technique when brushing. Using correct brushing technique when cleaning teeth would allow people to use their time effectively and help them prevent tooth decay.

Brushing teeth with an incorrect brushing technique doesn't help people prevent tooth decay and it damages the teeth and gums. Incorrect brushing technique brings the risks of permanently damaging the protective layer on teeth and harming gums, which eventually leads to “receding gums” and tooth sensitivity. Applying too much pressure when brushing teeth is one of the leading factors causing damage to teeth and it is easy to apply excessive pressure to people's teeth while brushing due to the small size of the contact area between teeth and toothbrush.

Most people hold toothbrushes with their fists when brushing and most toothbrushes on the market have been designed to enable people to hold the toothbrush in a palm grip comfortably. Dental research has however shown that more gingival injuries were found when the toothbrush was held with a palm grip than with a pen grip.(The effect of toothbrush grip on gingival abrasion and plaque removal during toothbrushing, Journal of Clinical Periodontology.1987 Jan;14(1):19-21).

Toothbrushes are becoming more advanced to prevent people from using too much pressure while brushing teeth. Some electric toothbrushes alert users with light, sound or will even stop rotating when the user brushes too hard. Some children's toothbrushes have been designed with audible signals that may adjust during brushing according to the pressure applied. The problem with these existing methods is that they provide feedback to the user only after too much pressure has been applied. In addition this advanced technology is only available in electric toothbrushes.

The current invention allows the user, whatever the age, to hold the toothbrush with a pen grip and in a manner that prevents them from applying excessive pressure while brushing their teeth. The handle design can be applied to electric and manual toothbrushes.

Brushing teeth at a 45 degree angle against the gum line is recommended to ensure that people clean their gums effectively and prevent the generation of biofilm plaque that is normally generated. In order to avoid the risk of damaging the tooth and gum line it is important to employ delicate motion when using the toothbrush in order to apply correct brushing motion gently on individual small teeth.

There is an electric toothbrush which guides the user as to their angle of brushing by giving audio/visual feedbacks. However, these toothbrushes require the use of motion sensors (for example, a gyroscope, an accelerometer etc.) to detect the brushing angle. The current invention avoids the need for complex electrical sensors and provides immediate intuitive visual feedback to the user through simple design to ensure that they brush at the correct angle.

Another disadvantage of existing brushes is that all such motion detecting and feedback features are only applied to electric toothbrushes, whereas we are living in a world where most people still use a manual toothbrush to brush their teeth. The current invention can be electric or manual.

### INTRODUCTION TO THE DRAWINGS

For a better understanding of the invention and to show where the finger locators are located on the toothbrush handle as well as to show how to hold a toothbrush in a pen grip while brushing teeth by way of examples in which:

FIG. 1 shows front view of a toothbrush in accordance with the present invention

FIG. 2 shows profile view of a toothbrush in accordance with the present invention

FIG. 3 shows a cross-section view of the handle of the invention taken along lines 3-3 of FIG. 1

FIG. 4 shows an alternative toothbrush in a cuboid format

FIG. 5 shows a cross-section view of toothbrush handle taken along lines 5-5 of FIG. 4

FIG. 6 shows a perspective view of a toothbrush in accordance with the present invention

FIG. 7 shows a view of a toothbrush with holding hand in the same view as FIG. 6

FIG. 8 shows a perspective view of a toothbrush with a further embodiment with a button 108

FIG. 9 shows a perspective view of a toothbrush with holding hand

FIG. 10A, 10B, 10C show the toothbrush of the current invention being held in three different positions with the fingers and thumb positioned in the different finger locator zones according to which section of teeth is to be cleaned

FIG. 11 shows a perspective view of a detachable toothbrush handle attachment

### DETAILED DESCRIPTION

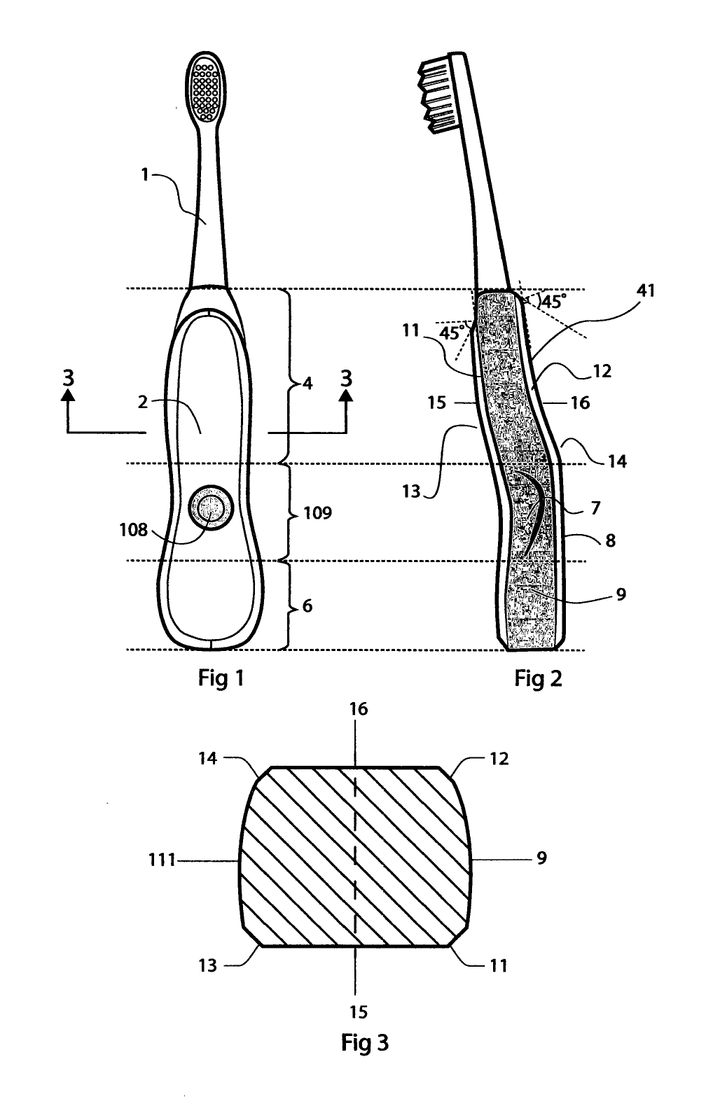

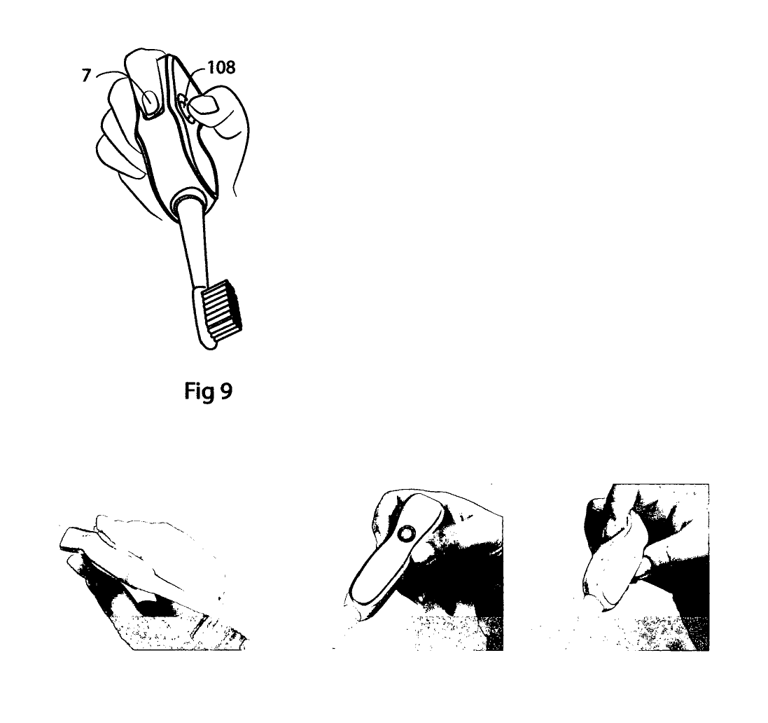

As shown in FIG. 1, one preferred embodiment of the toothbrush of the present invention has a handle 2 and attachable head 1. The handle is notionally divided into a proximal region 4, a central region 109 and a distal region 6. The central region 109 is located next to the distal region 6 of the toothbrush, and the length of the distal region can be such that it enables users to put their palm around the end of the handle, as shown in FIG. 8, while their fingers engage the central region 109. Preferably a shorter handle in the current embodiment compared to standard current toothbrushes helps to reduce the risk of pressure being applied to the gums and teeth.

A thumb zone 108 is provided on the front surface 15 in FIG. 2 of the toothbrush (i.e. the surface lying on the same side as the toothbrush bristles) in the central region 109, as shown in FIG. 1; The thumb zone 108 could be a depression on the toothbrush handle in the central zone 109 to assist in locating the user's thumb. However, in an alternative embodiment, the thumb zone 108 may include an on/off switch or raised pattern on the toothbrush handle, or an embedded conductive or inductive material at thumb zone 108 that can, as explained in further details below, initiate other functionality within the toothbrush.

In one case, the inductive zone 108 could be powered up when the user contacts it with a finger or thumb. This could generate an electrical signal which could be used to link the toothbrush with an audio soundtrack, or could generate a digital signal to interact with other devices, e.g. to record data relating to the user's tooth brushing.

As shown in FIG. 2, the toothbrush handle also comprises four chamfered surfaces, 11,12,13,14 arranged at an angle of approximately 45 degree to the front surface 15 of the toothbrush handle and the back surface 16 of the toothbrush handle. This is best seen in FIG. 3, which is a cross-section view of the handle of the invention taken along lines 3-3 of FIG. 1.

There is a finger locator zone 7 on the side surface 9 of the toothbrush handle and also on another finger locator zone 8 on the opposite side surface 111 (better illustrated in FIG. 3) and optionally the thumb zone 108 on the front surface could also act as a finger locator zone in some embodiments as well. There is also an index finger locator zone 41 on the back of the handle. The finger locators 7 and 8 are profiled zones that a user can feel them and they are located in positions to ensure that the toothbrush is held correctly and consistently. The finger locator zones could be engaged by the user's thumb, index finger and middle finger according to how people brush their teeth. The toothbrush can be symmetrical about a longitudinal plane that bisects the head.

FIG. 2 shows a preferable embodiment in which the front surface 15 and back surface 16 are angled to create a bend in the handle which gives the user better ergonomic grip. In addition, the front and back surfaces 15 and 16 taper inwards at the central region 109 making the brush handle narrower around the central region thereby forming a waist. For example, the tapering could end in the region of the finger locator zones 7 and 8 on the side surfaces, thereby forming a waist which would enable the user to locate their fingers (illustrated in FIG. 10A, 10B and 10C) at the finger zones comfortably and prevent the fingers slipping on the body of the handle in wet environments like bathrooms. Also the tapered handle allows users with different sizes of fingers locate their fingers comfortably on the finger locators at the side surfaces of the toothbrush handle.

In FIG. 2, preferably, the central region 109 is located nearer to the distal region than to the proximal region. The middle of the central region is preferred to be less than 4 cm from the distal end of the handle, thereby allowing the user to grasp the handle by the side surfaces between his thumb and middle finger located on finger locator zone 7 and 8, preferably, with an allowance of space between the distal end of the toothbrush and palm, as shown in FIG. 8.

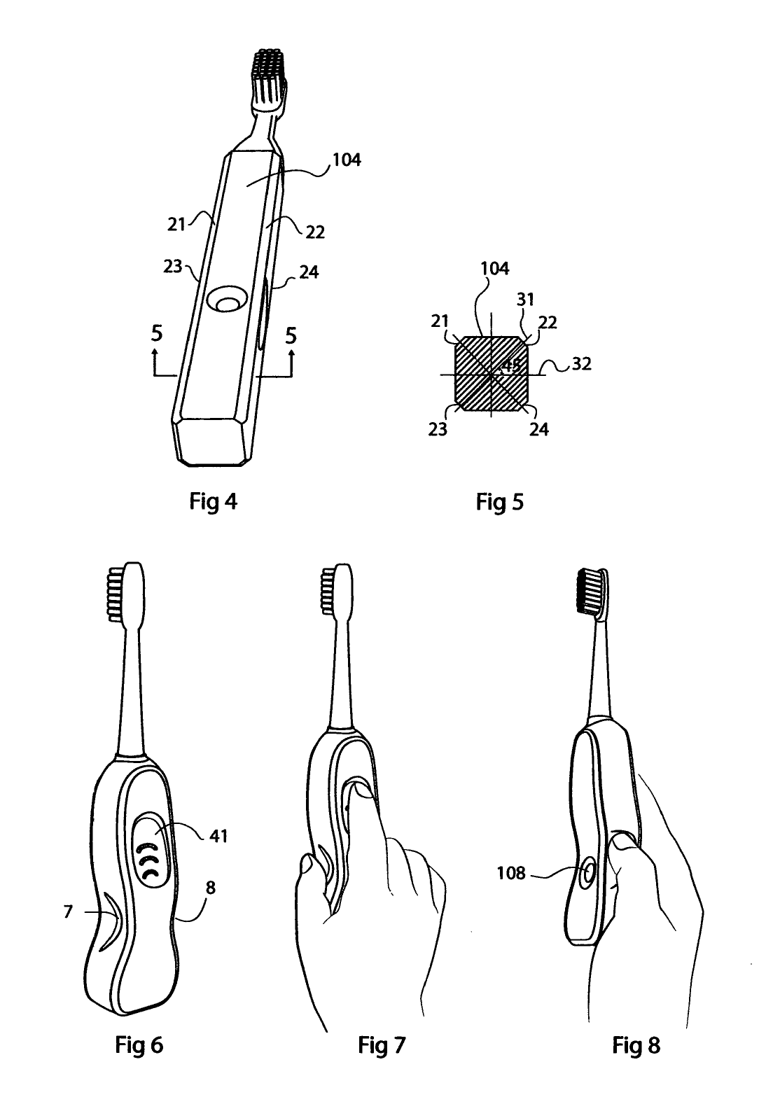

Turning to FIG. 4, there is an alternative embodiment of the toothbrush handle. The toothbrush handle is comprised with eight surfaces around a longitudinal axis. Chamfered edges 21,22,23,24 are equivalent to surfaces 11,12,13,14 in FIG. 2. Chamfered edges 23 and 24 are located between the back surface and side surfaces, chamfered edges 21 and 22 are located between the front surface and side surfaces. As shown in FIG. 5, surfaces 21,22,23,24 are arranged at a 45 degree angle with respect to a longitudinal plane 32 through the handle. Take surface 22 as an example, plane 31 of surface 22 lies at approximately 45 degree to plane 32 of the toothbrush handle.

In one embodiment these chamfered surfaces can be associated with visual means, the visual means could be illuminated, and profiled or a decorative pattern, so that it is visible to the user when the bristles are oriented at an angle to the horizontal thereby providing an indication that the head is correctly oriented for the brushing of the user's teeth. This means that the user can use the visual means as a reference when they rotate the toothbrush in the mouth to reach the gum line while brushing different sections of teeth. Plaque, is the main cause of tooth decay and is mostly generated around the gum line which is why it is widely recommended, by dental professionals, that people should hold the toothbrush with a 45 degree angle against the gum line. By using the chamfered edges as a visual reference, correct orientation of the toothbrush becomes a visual guide and enables the user to adjust the brush orientation precisely.

It could be that each chamfered edge has a different colour to differentiate one from another. When a user brushes different areas of their teeth, they would try to adjust their toothbrush position so that they could see the chamfered edge with required colour in order to adjust their handle to the correct angle against their gum line. In this way they could correctly clean the different sections of their teeth.

At FIGS. 6 and 7, there is seen index finger locator zone 41, which could be profiled so that the user can feel it on the back of the toothbrush handle (or the zone could be a depression or raised). Finger locator zones 7 and 8 on the side surfaces of the handle provide profiled contact zones for the user's thumb and middle finger while the index finger can be located at index finger locator zone 41 as shown in FIG. 7. In this way, the user's thumb and middle finger are guided to locate on the opposite surfaces of toothbrush handle to form a pen grip while brushing the teeth.

One preferable embodiment is shown in FIG. 6 in which the index finger locator zone 41 is located on the back surface of the toothbrush. The index finger locator zone 41 could be located further towards the head of the toothbrush than the finger locator zones on the side surfaces as shown in FIG. 6. This would enable the index finger to locate on the back surface of the toothbrush handle intuitively while thumb and middle finger locate on the side surfaces. This would facilitate the user to grasp the toothbrush in a manner similar to the grasping of a pencil. Using three fingers located on different surfaces of the toothbrush increases the controllability of moving the toothbrush and applying delicate motion while brushing teeth.

As best seen in FIG. 2, the toothbrush handle includes a bend located part of the way along the handle when viewed sideways. This makes it more comfortable to locate thumb and middle finger on the finger locators 7 and 8 on the side surface of toothbrush near to the distal end of the handle while locating index finger on the index finger locator 41 on the back surface of the toothbrush.

Turning now to FIG. 9, this shows another perspective view of the toothbrush handle. It shows how the current embodiment allows a user to grasp the handle in a different way with the thumb contacting the thumb zone and the index finger contacting the finger locator zone 7 on the side surface 9 of the toothbrush handle.

This grip is used to brush certain sections of teeth at the correct angle without excessive pressure.

FIG. 10 of the invention shows that various finger positions are possible on the toothbrush handle to provide comfort for the user when brushing particular areas of their teeth but still keeping their thumb and middle finger on the opposite surfaces of toothbrush handle to form a pen grip intuitively.

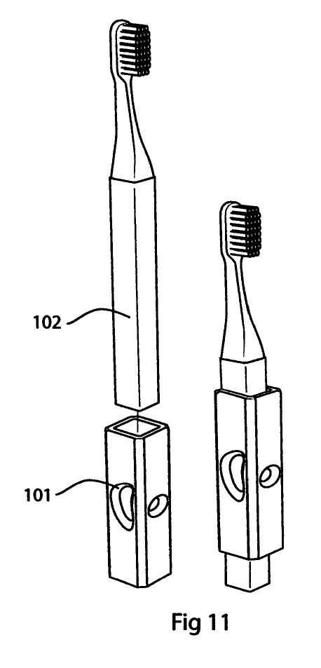

As shown in FIG. 11, in another embodiment, the toothbrush handle with the features described above could also be an attachment 101 to toothbrush 102. The attachment 101 has finger locaters as described above in order to facilitate the user to hold the toothbrush like a pencil. Preferably, the attachment has flexible walls to make it easy to attach it to different sized toothbrushes.

1. A toothbrush having a handle and a head including bristles, wherein the handle comprises a front surface located on the same side of the toothbrush as the bristles, a back surface and a pair of opposed side surfaces, wherein the two side surfaces and the back surface each includes a zone marked or shaped for receiving a finger or thumb of a user.

2. A toothbrush as claimed in claim 1, wherein the front and back surfaces taper from the head end and/or distal end of the handle towards the region of the zones on the side surfaces, e.g. to form a waist in the region of the zones on the side surfaces.

3. A toothbrush as claimed in claim 1, wherein the zone on the back surface is located at the same distance along the handle, or further towards the head, as the zones on the side surfaces.

4. A toothbrush as claimed in claim 1, wherein the handle includes chamfered edges located between the back surface and at least one of the side surfaces so that it is visible to the user when the bristles are oriented at an angle to the horizontal thereby providing an indication that the head is correctly oriented for the brushing of the user's teeth.

5. A toothbrush as claimed in claim 4, wherein the or each chamfered edge lies at approximately 45° to the adjacent back and side surfaces.

6. A toothbrush as claimed in claim 4, wherein at least one chamfered edge is visually different, e.g. has a different colour or pattern, from the adjacent back and side surfaces and/or from each other, for example, the at least one chamfered edge could emit light and the light from different edges could be of different appearances.

7. A toothbrush as claimed in claim 4, wherein there is a chamfered edge between the front surface and each of the side edges and optionally also between the back surface and each of the side edges.

8. A toothbrush as claimed in claim 1, wherein the zones are located to facilitate the user grasping the handle in a manner similar to the grasping of a pencil or pen.

9. A toothbrush as claimed in claim 1, wherein the handle has a proximal end nearer the head and a distal end further away from the head wherein the zones are located part of the way along the length of the handle, and wherein the zones are located nearer the distal end of the handle than the proximal end of the handle.

10. (canceled)

11. A toothbrush as claimed in claim 8, wherein the zones on the side surfaces are located less than or equal to 5 cm from the distal end of the handle, thereby allowing the user to grasp the handle by the side surfaces between his thumb and middle finger.

12. A toothbrush as claimed in claim 1, wherein the handle includes a bend located part of the way along the handle when viewed sideways, e.g. in the region of the zones on the side surfaces.

13. A toothbrush as claimed claim 1, wherein the zones on the side surfaces and the back surface are each selected from a concave or convex region, a raised, recessed or textured pattern or a region bordered by a ridge, and one of them, e.g. on the back surface, can be in the form of a switch, e.g. a button or conductive region, to operate the toothbrush when the toothbrush is electrically powered.

14. A toothbrush as claimed in claim 1, wherein at least one of the zones provides feedback if touched, for example, it could generate a sound or send out digital signals to power up or interact with other devices, for example a data-logging device.

15. A toothbrush handle configured for attachment to a removable toothbrush head at one end of the handle, wherein the handle comprises a front surface, a back surface and a pair of opposed side surfaces, wherein the two side surfaces and the back surface each includes a zone marked or shaped for receiving a finger or thumb of a user.

16.-29. (canceled)

30. An attachment configured for attachment to the handle of a toothbrush that has a head and a handle having an end proximate to the head and a remote end, the attachment having a recess for fitting over the handle, e.g. over the remote end of the handle, and being configured to grip the handle, wherein the attachment comprises a front surface, a back surface and a pair of opposed side surfaces, wherein the two side surfaces and the back surface each includes a zone marked or shaped for receiving a finger or thumb of a user.

31. A toothbrush handle attachment as claimed in claim 30, wherein the recess has an open end and a closed end so that it is configured to fit onto the distal end of the handle.

32. A toothbrush handle attachment as claimed in claim 30, wherein the recess has two open ends so that it is in the form of a sleeve that is configured to fit around the handle.

33. A toothbrush handle attachment as claimed in claim 30, wherein the recess has flexible and resilient side walls that can grip the handle.

34. (canceled)

35. A toothbrush having a handle and a head including bristles, wherein the handle comprises a front surface located on the same side of the toothbrush as the bristles, a back surface and a pair of opposed side surfaces, wherein the handle includes chamfered edges located between the back surface and at least one of the side surfaces so that it is visible to the user when the bristles are oriented at an angle to the horizontal thereby providing an indication that the head is correctly oriented for the brushing of the user's teeth.

36. A toothbrush handle configured for attachment to a removable toothbrush head at one end of the handle, wherein the handle comprises a front surface, a back surface and a pair of opposed side surfaces, wherein the handle includes a chamfered edge located between the back surface and at least one of the side surfaces so that it is visible to the user when the bristles are oriented at an angle to the horizontal thereby providing an indication that the head is correctly oriented for brushing of the user's teeth.
